(19) United States
(12) Patent Application Publication
(10) Pub. No.: US 2009/0146913 A1
(43) Pub. Date: Jun. 11, 2009

(54) DISPLAY DEVICE

(75) Inventor: Takahisa Tanabe, Saitama (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION, Meguro-ku, Tokyo (JP)

(21) Appl. No.: 11/995,595

(22) PCT Filed: Jul. 13, 2006
(86) PCT No.: PCT/JP2006/314325

§ 371 Date: Jan. 14, 2008

(30) Foreign Application Priority Data
Jul. 14, 2005 (JP) 2005-205443

(51) Int. Cl. G09G 5/00

(52) U.S. Cl. 345/3.1

(57) ABSTRACT

There is provided a display device capable of switching the display mode between liquid crystal display and electroluminescence display using a single display panel. The display device includes a driver that generates an EL pixel data pulse according to the brightness level represented by an input image signal during an EL display mode, while generating a liquid crystal pixel data pulse according to the brightness level during a liquid crystal display mode. Each pixel cell includes a dual display element having liquid crystal and EL display functions, and drive means for applying an EL drive voltage to the dual display element according to the EL pixel data pulse, and applying a liquid crystal drive voltage according to the liquid crystal pixel data pulse.

### TECHNICAL FIELD

The present invention relates to a matrix display device.

### BACKGROUND ART

Nowadays, an electroluminescence (hereinafter referred to as EL) device is known as a thin display device. Furthermore, in recent years, Japanese Patent Kokai No. 2002-25779, for example, proposes a display panel in which a layer of liquid crystal, such as nematic liquid crystal, is stacked on or mixed in a carrier transport layer or an organic light emitting layer of an EL element.

Therefore, in such a display panel, use of a driver for liquid crystal driving allows liquid crystal display, while use of a driver for EL driving allows EL display. However, since driving liquid crystal differs from driving an EL element in terms of drive conditions, it has been difficult to switch between EL display and liquid crystal display as appropriate in a single display panel.

The invention has been made to solve the above problem and aims to provide a display device capable of switching the display mode between liquid crystal display and EL display.

### DISCLOSURE OF THE INVENTION

The display device according to claim 1 is a display device equipped with a display panel on which a plurality of pixel cells serving as pixels are formed. The display device includes a driver that generates an electroluminescence pixel data pulse according to the brightness level represented by pixel data for each pixel based on an input image signal during an EL display mode, while generating a liquid crystal pixel data pulse according to the brightness level represented by the pixel data during a liquid crystal display mode. Each of the pixel cells includes a display element capable of performing electroluminescence display operation and liquid crystal display operation, and drive means for applying an electroluminescence drive voltage to the display element according to the EL pixel data pulse, and applying a liquid crystal drive voltage to the display element according to the liquid crystal pixel data pulse.

### BRIEF DESCRIPTION OF THE DRAWINGS

FIG. 1 is a diagram showing the configuration of a display device;

FIG. 2 is a diagram showing the configuration of a pixel cell G provided in the display panel 10 shown in FIG. 1;

FIG. 3 is a diagram showing the configuration of a dual display element DM;

FIG. 4 is a diagram showing the voltage-brightness characteristic of the dual display element DM;

FIG. 5 is a diagram showing an example of drive pulses applied to the pixel cell G during an EL display mode in the display device shown in FIG. 1;

FIG. 6 is a diagram showing an example of drive pulses applied to the pixel cell G during a liquid crystal display mode in the display device shown in FIG. 1;

FIG. 7 is a diagram showing another example of drive pulses applied to the pixel cell G during the liquid crystal display mode in the display device shown in FIG. 1;

FIG. 8 a diagram showing another configuration of the display device;

FIG. 9 is a diagram showing the configuration of a pixel cell G1 provided in the display panel 100 shown in FIG. 8;

FIG. 10 is a diagram showing another configuration of the display device;

FIG. 11 is a diagram showing the configuration of a pixel cell G21 provided in the display panel 110 shown in FIG. 10;

FIG. 12 is a diagram showing the characteristic of the gate-source voltage V_{GS} versus the drain-source current I_{DS} of each of transistors Q1, Q2, Q4 and Q5 in the pixel cell G2;

FIG. 13 is a diagram showing the internal configuration of the data driver 123 shown in FIG. 10;

FIG. 14 is a diagram showing an example of drive pulses applied to the pixel cell G2 during an EL display mode in the display device shown in FIG. 10;

FIG. 15 is a diagram showing an example of drive pulses applied to the pixel cell G2 during a liquid crystal display mode in the display device shown in FIG. 10;

FIG. 16 is a diagram showing another configuration of the pixel cell G when the transistors Q1 to Q3 shown in FIG. 2 are constructed by n-channel field-effect transistors;

FIG. 17 is a diagram showing another configuration of the pixel cell G1 when the transistors Q1 and Q2 shown in FIG. 9 are constructed by n-channel field-effect transistors; and

FIG. 18 is a diagram showing another configuration of the pixel cell G2 when the transistors Q1, Q2, Q4 and Q5 shown in FIG. 11 are constructed by n-channel field-effect transistors.

### EMBODIMENT OF THE INVENTION

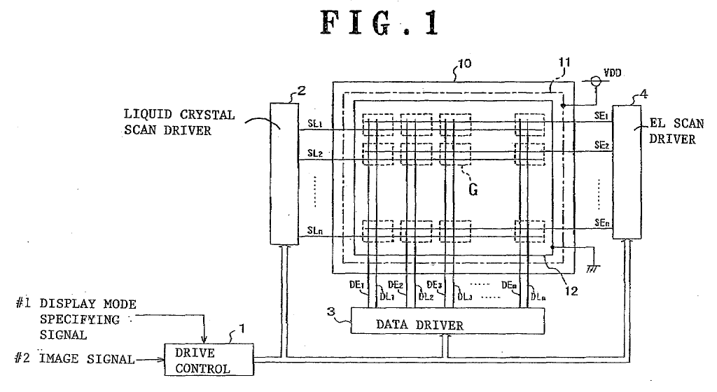

FIG. 1 shows an example of a schematic configuration of the display device according to a first embodiment of the invention.

In FIG. 1, a display panel 10 includes data lines DL₁ to DLₘ and data lines DE₁ to DEₘ, each extending in the longitudinal direction (vertical direction) in a two-dimensional display screen, with the DLs and DEs alternately disposed as shown in FIG. 1. The display panel 10 also includes scan lines SL₁ to SLₙ and scan lines SE₁ to SEₙ, each extending in the lateral direction (horizontal direction) in the two-dimensional display screen, with the SLs and SEs alternately disposed as shown in FIG. 1. A pixel cell G (indicated by the broken line) corresponding to a pixel is formed at the intersection of a pair of scan lines consisting of an SL and an SE adjacent to each other and a pair of data lines consisting of DL and DE adjacent to each other. An EL drive voltage VDD used to drive an EL element for light emission is applied to each pixel cell G via a power supply electrode 11. A ground potential is also applied to each pixel cell G via a ground electrode 12.

A drive control circuit 1 generates a liquid crystal scan timing signal and supplies it to a liquid crystal scan driver 2 when a display mode specifying signal indicates a liquid crystal display mode. The drive control circuit 1 also supplies the liquid crystal display mode signal to a data driver 3. On the other hand, when the display mode specifying signal indicates an EL display mode, the drive control circuit 1 generates an EL scan timing signal and supplies it to an EL scan driver 4. The drive control circuit 1 also supplies the EL display mode signal to the data driver 3. Furthermore, the drive control circuit 1 converts an input image signal into pixel data representing the brightness levels of the pixels and supplies the pixel data to the data driver 3.

The liquid crystal scan driver 2 sequentially applies liquid crystal scan pulses (which will be described later) to the scan lines SL₁ to SLₙ in the display panel 10 according to the liquid crystal scan timing signal. The EL scan driver 4 sequentially applies EL scan pulses (which will be described later) to the scan lines SE₁ to SEₙ in the display panel 10 according to the EL scan timing signal. When the drive control circuit 1 supplies the liquid crystal display mode signal, the data driver 3 generates pixel data pulses having liquid crystal drive voltages according to the pixel data and applies these pulses to the data lines DL₁ to DLₘ on a single scan line basis (m pulses). On the other hand, when the drive control circuit 1 supplies the EL display mode signal, the data driver 3 generates pixel data pulses according to the pixel data and applies these pulses to the data lines DE₁ to DEₘ on a single scan line basis (m pulses).

When the pixel cells G in the display panel 10 receive the liquid crystal scan pulses via the scan lines SL₁ to SLₙ and the pixel data pulses via the data lines DL₁ to DLₘ, the display panel 10 is operated as a liquid crystal display panel. On the other hand, when the pixel cells G receive the EL scan pulses via the scan lines SE₁ to SEₙ and the pixel data pulses via the data lines DE₁ to DEₘ, the display panel 10 is operated as an EL display panel by the pixel cells G.

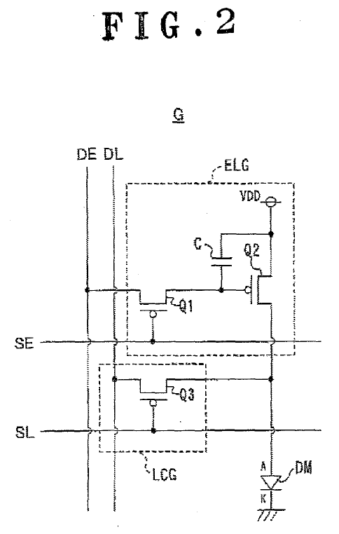

FIG. 2 shows the configuration of the pixel cell G.

As shown in FIG. 2, the pixel cell G includes a dual display element DM having both an EL (electroluminescence) display function and a liquid crystal display function, an EL drive circuit ELG, and a liquid crystal drive circuit LCG.

The EL drive circuit ELG includes a transistor Q1 for acquiring pixel data, a transistor Q2 for supplying an EL drive current, and a capacitor C. The transistors Q1 and Q2 are p-channel field-effect transistors.

The gate electrode of the transistor Q1 is connected to the scan line SE, and the source electrode of the transistor Q1 is connected to the data line DE. The drain electrode of the transistor Q1 is connected to the gate electrode of the transistor Q2. The EL drive voltage VDD is applied to the source electrode of the transistor Q2 via the power supply electrode 11, and the capacitor C is connected between the gate and source electrodes of the transistor Q2. Furthermore, the drain electrode of the transistor Q2 is connected to the anode electrode A of the dual display element DM. The cathode electrode K of the dual display element DM is grounded via the ground electrode 12.

The liquid crystal drive circuit LCG includes a transistor Q3. The gate electrode of the transistor Q3 is connected to the scan line SL, and the source electrode of the transistor Q3 is connected to the data line DL. The drain electrode of the transistor Q3 is connected to the anode electrode A of the dual display element DM. The transistor Q3 is a p-channel field-effect transistor.

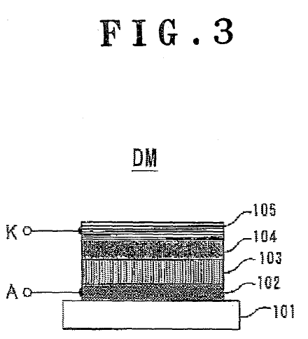

FIG. 3 is a cross-sectional view of the dual display element DM.

As shown in FIG. 3, the dual display element DM includes a transparent substrate 101 formed of a transparent glass or transparent resin sheet or the like, on which a transparent electrode 102 made of ITO or the like, a carrier transport layer 103 in which nematic liquid crystal is mixed, an organic light emitting layer 104, and a rear electrode 105 are stacked. The transparent electrode 102 is the anode electrode A of the dual display element DM, and the rear electrode 105 is the cathode electrode K. The nematic liquid crystal may be mixed in the organic light emitting layer 104 instead of the carrier transport layer 103. Alternatively, the nematic liquid crystal may be mixed in both the carrier transport layer 103 and the organic light emitting layer 104.

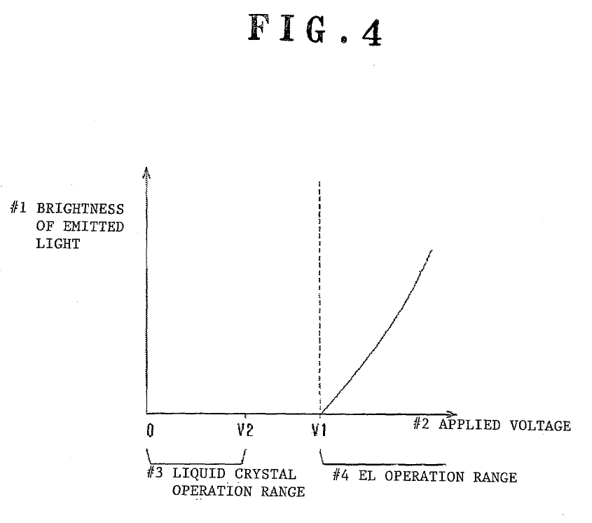

FIG. 4 shows how the voltage applied between the anode electrode A and the cathode electrode K of the dual display element DM relates to the brightness of the light emitted from the organic light emitting layer 104 of the dual display element DM.

As shown in FIG. 4, when a voltage greater than a predetermined first voltage V1 (50 volts, for example) is applied between the anode electrode A and the cathode electrode K, the organic light emitting layer 104 emits light. When a voltage having a value ranging from 0 volts to a second voltage V2 (25 volts, for example) is applied between the anode electrode A and the cathode electrode K, the orientation of the liquid crystal molecules mixed in the carrier transport layer 103 changes according to the applied voltage.

That is, the dual display element DM operates as a liquid crystal display element when a voltage lower than the second voltage V2 is applied between the anode electrode A and the cathode electrode K, while operating as an EL display element when a voltage higher than the first voltage V1 is applied. The EL drive voltage VDD is therefore set to a voltage higher than the first voltage V1.

The operation of the display device shown in FIG. 1 will now be described.

The display device is driven as an EL display device based on the following EL display mode when the display mode specifying signal indicates the EL display mode, while being driven as a liquid crystal display device based on the following liquid crystal display mode when the display mode specifying signal indicates the liquid crystal display mode.

### [EL Display Mode]

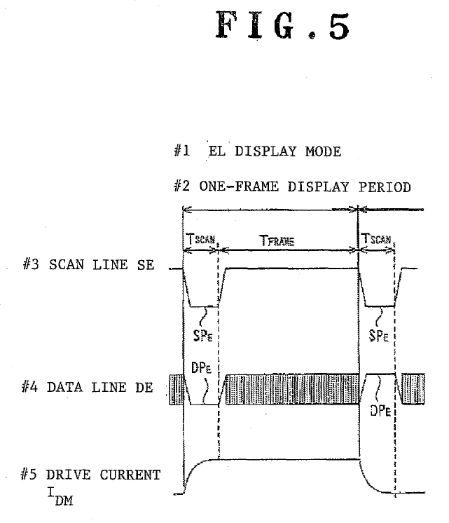

In the EL display mode, as shown in FIG. 5, the EL scan driver 4 sequentially applies an EL scan pulse SP_{E} having, for example, a pulse voltage of 0 volts, which is adequate enough to turn the transistor on, to the scan lines SE₁ to SEₙ for each scan period T_{SCAN} in each frame display period. During this period, the data driver 3 generates a pixel data pulse DP_{E} having a pulse voltage according to the brightness level represented by the pixel data. The data driver 3 then applies these pulses to the data lines DE₁ to DEₘ on a single scan line basis (m pulses) synchronized with the application timing of each EL scan pulse SP_{E}. It is noted that FIG. 5 shows the scan pulse and the pixel data pulse applied to only one representative pixel cell G.

When the EL scan pulse SP_{E} is applied to the pixel cell G during the scan period T_{SCAN} as shown in FIG. 5, the transistor Q1 in the EL drive circuit ELG in the pixel cell G is turned on, so that the pulse voltage of the pixel data pulse DP_{E} is applied to the capacitor C via the data line DE. Then, electric charge corresponding to this pulse voltage is charged in the capacitor C, and such charging increases the voltage across the capacitor C. The voltage generated in the capacitor C becomes the gate voltage of the transistor Q2. The transistor Q2 generates a drive current I_{DM} according to the gate voltage and delivers this current to the dual display element DM during a display period T_{FRAME} shown in FIG. 5. During this period, the organic light emitting layer 104 in the dual display element DM emits light at the brightness level according to the drive current I_{DM}. That is, the dual display element DM operates as an EL display element.

### [Liquid Crystal Display Mode]

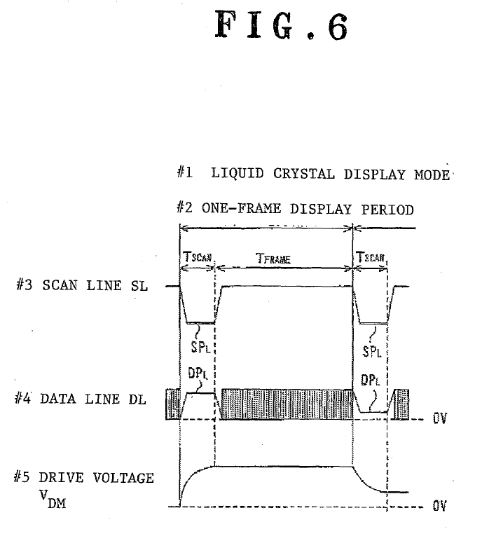

In the liquid crystal display mode, the liquid crystal scan driver 2 sequentially applies a liquid crystal scan pulse SP_{L} having, for example, a pulse voltage of 0 volts to the scan lines SL₁ to SLₙ for each scan period T_{SCAN} in each frame display period as shown in FIG. 6. During this period, the data driver 3 generates a pixel data pulse DP_{L} having a liquid crystal drive pulse voltage according to the brightness level represented by the pixel data. The data driver 3 then applies these pulses to the data lines DL₁ to DLₘ on a single scan line basis (m pulses) synchronized with the application timing of each liquid crystal scan pulse SP_{L}. It is noted that the liquid crystal drive pulse voltage has a value ranging from 0 volts to the second voltage V2, as shown in FIG. 4.

When the liquid crystal scan pulse SP_{L} is applied to the pixel cell G during the scan period T_{SCAN}, the transistor Q3 in the liquid crystal drive circuit LCG in the pixel cell G is turned on, so that the pixel data pulse DP_{L} is applied to the dual display element DM via the data line DL. Then, electric charge corresponding to the pulse voltage of the pixel data pulse DP_{L} is stored in the dual display element DM, and the drive voltage V_{DM} corresponding to this stored electric charge is generated between the anode electrode A and the cathode electrode K of the dual display element DM during the display period T_{FRAME} as shown in FIG. 6. Since the drive voltage V_{DM} generated between the anode electrode A and the cathode electrode K ranges from 0 volts to the second voltage V2, the orientation of the liquid crystal molecules mixed in the carrier transport layer 103 in the dual display element DM changes according to the generated voltage. That is, the dual display element DM operates as a liquid crystal display element.

As described above, in the display device shown in FIG. 1, by providing the EL drive circuit ELG and the liquid crystal drive circuit LCG in each of the pixel cells G and selectively operating these drive circuits, the dual display element DM can be switched between an EL display element and a liquid crystal display element as appropriate and operated accordingly.

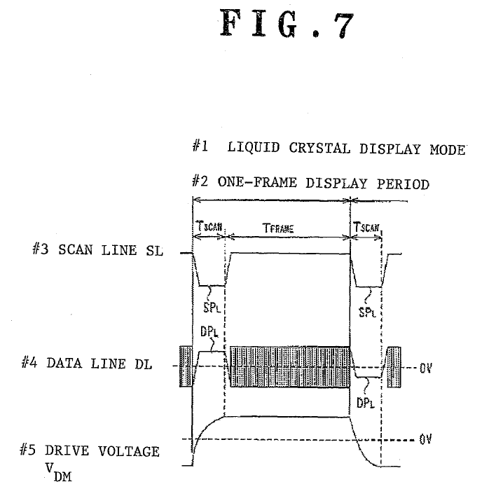

In the liquid crystal display mode shown in FIG. 6, direct current driving is used to drive the dual display element DM in such a way that the anode electrode A of the dual display element DM always has a higher potential than that of the cathode electrode K. However, as shown in FIG. 7, alternate current driving may be employed, in which the polarities of the anode electrode A and the cathode electrode K alternate every one-frame display period.

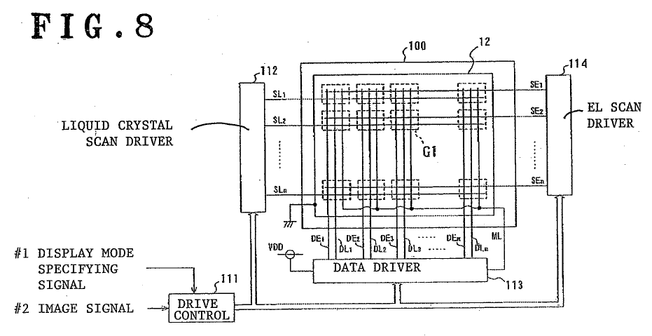

FIG. 8 shows another example of a schematic configuration of the display device according to a second embodiment of the invention.

In FIG. 8, a display panel 100 includes data lines DL₁ to DLₘ and data lines DE₁ to DEₘ, each extending in the longitudinal direction (vertical direction) in a two-dimensional display screen, with the DLs and DEs alternately disposed as shown in FIG. 8. The display panel 100 also includes scan lines SL₁ to SLₙ and scan lines SE₁ to SEₙ, each extending in the lateral direction (horizontal direction) in the two-dimensional display screen, with the SLs and SEs alternately disposed as shown in FIG. 8. A pixel cell G1 (indicated by the broken line) corresponding to a pixel is formed at the intersection of a pair of scan lines consisting of an SL and an SE adjacent to each other and a pair of data line consisting of DL and DE adjacent to each other. The pixel cells G1 are connected commonly via a mode electrode ML and a ground potential is applied to each of the pixel cells G1 via a ground electrode 12.

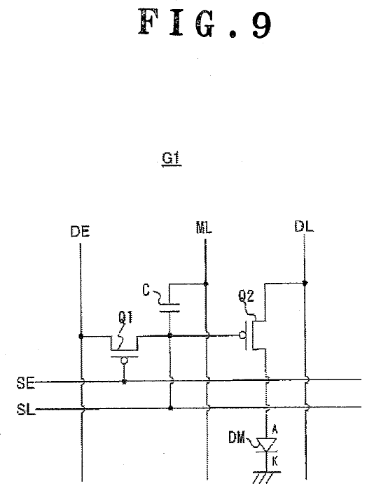

FIG. 9 shows the configuration of the pixel cell G1.

As shown in FIG. 9, each of the pixel cells G1 includes a dual display element DM having both an EL display function and a liquid crystal display function, a transistor Q1 for acquiring pixel data, a transistor Q2 for supplying a drive current, and a capacitor C. The transistors Q1 and Q2 are p-channel field-effect transistors.

The gate electrode of the transistor Q1 is connected to the scan line SE, and the source electrode of the transistor Q1 is connected to the data line DE. The drain electrode of the transistor Q1 is connected to the gate electrode of the transistor Q2, the scan line SL, and one of the electrodes of the capacitor C. The other electrode of the capacitor C is connected to the mode electrode ML. The source electrode of the transistor Q2 is connected to the data line DL, and the drain electrode of the transistor Q2 is connected to the anode electrode A of the dual display element DM. The cathode electrode K of the dual display element DM is grounded via the ground electrode 12. The structure of the dual display element DM is the same as that shown in FIG. 2. The description thereof will therefore be omitted.

A drive control circuit 111 shown in FIG. 8 supplies a liquid crystal scan timing signal to a liquid crystal scan driver 112 when a display mode specifying signal indicates a liquid crystal display mode. The drive control circuit 111 also supplies the liquid crystal display mode signal to the liquid crystal scan driver 112, a data driver 113, and an EL scan driver 114. On the other hand, when the display mode specifying signal indicates an EL display mode, the drive control circuit 111 supplies an EL scan timing signal to the EL scan driver 114. The drive control circuit 111 also supplies the EL display mode signal to the liquid crystal scan driver 112, the data driver 3, and the EL scan driver 114. Furthermore, the drive control circuit 111 converts an input image signal into pixel data representing the brightness levels of the pixels and supplies them to the data driver 113.

The liquid crystal scan driver 112 sequentially applies the liquid crystal scan pulse SP_{L} shown in FIG. 6 to the scan lines SL₁ to SLₙ in the display panel 100 according to the liquid crystal scan timing signal.

The EL scan driver 114 sequentially applies the EL scan pulse SP_{E} shown in FIG. 5 to the scan lines SE₁ to SEₙ in the display panel 100 according to the EL scan timing signal.

When the drive control circuit 111 supplies the liquid crystal display mode signal, the data driver 113 generates the pixel data pulses DP_{L} shown in FIG. 6 having liquid crystal drive voltages according to the pixel data and applies these pulses to the data lines DL₁ to DLₘ on a single scan line basis (m pulses). On the other hand, when the EL display mode signal is supplied, the data driver 113 generates pixel data pulses DP_{E} shown in FIG. 5 having voltages according to the pixel data based on the EL drive voltage VDD and applies these pulses to the data lines DE₁ to DEₘ on a single scan line basis (m pulses).

When the drive control circuit 111 supplies the liquid crystal display mode signal, the EL scan driver 114 applies an EL off voltage VE_{OFF} having a voltage that should turn the transistor Q1 in the pixel cell G1 off to the gate electrodes of the transistors Q1 in all the pixel cells G1 via the scan lines SE₁ to SEₙ. Furthermore, the data driver 113 sets one of the electrodes of the capacitor C in each of all the pixel cells G1 to the high impedance state via the mode electrode ML in the display panel 100.

Therefore, during the liquid crystal display mode, the transistors Q1 and capacitors C in all the pixel cells G1 are disabled, and only the transistors Q2 and the dual display elements DM are operable. Since the gate electrode of the transistor Q2 is connected to the scan line SL and the source electrode of the transistor Q2 is connected to the data line DL, the transistor Q2 is equivalent to the liquid crystal drive circuit LCG shown in FIG. 2 at this point. Therefore, as with the liquid crystal drive circuit LCG, the transistor Q2 drives the dual display element DM in the liquid crystal mode shown in FIG. 6.

On the other hand, when the drive control circuit 111 supplies the EL display mode signal, the data driver 113 applies the EL drive voltage VDD to the other electrode of the capacitor and the source electrode of the transistor Q2 in each of all the pixel cells G1 via the mode electrode ML and each of the data lines DL₁ to DLₘ.

Therefore, during the EL display mode, the pixel cell G1 has a configuration equivalent to that of the EL drive circuit ELG shown in FIG. 2. Therefore, as with the EL drive circuit ELG, the pixel cell G1 drives the dual display element DM in the EL display mode shown in FIG. 5.

As described above, in the display device shown in FIG. 8, the transistor Q2 for supplying the EL drive current in each pixel cell G1 also serves as the transistor for liquid crystal driving, the pixel cell G1 can be smaller than the pixel cell G shown in FIG. 2.

During the liquid crystal display mode, when an excessive current flows through the dual display element DM, the electric charge stored in the dual display element DM is discharged, resulting in voltage drop and unstable grayscale display. To address this problem, during the liquid crystal display mode, a fixed drive voltage may be applied to the dual display element DM, as in the EL display mode, so as to allow the flowing current to have a predetermined fixed value.

### Third Embodiment

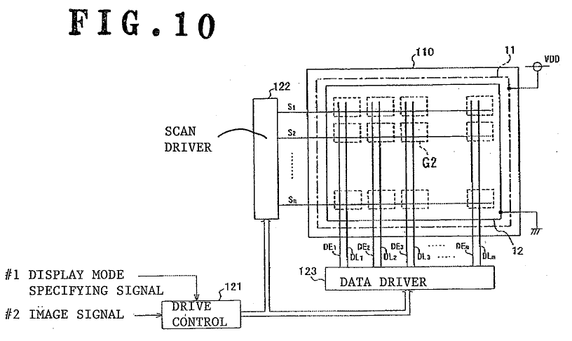

FIG. 10 shows another configuration of the display device according to the invention.

In FIG. 10, a display panel 110 includes data lines DL₁ to DLₘ and data lines DE₁ to DEₘ, each extending in the longitudinal direction (vertical direction) in a two-dimensional display screen, with the DLs and DEs alternately disposed as shown in FIG. 10. The display panel 110 also includes scan lines S₁ to Sₙ, each extending in the lateral direction (horizontal direction) in the two-dimensional display screen. A pixel cell G2 (indicated by the broken line) corresponding to a pixel is formed at the intersection of a scan line S and a pair of data lines consisting of DL and DE adjacent to each other. An EL drive voltage VDD used to drive an EL element for light emission is applied to each pixel cell G2 via a power supply electrode 11, and a ground potential is applied to each pixel G2 via a ground electrode 12.

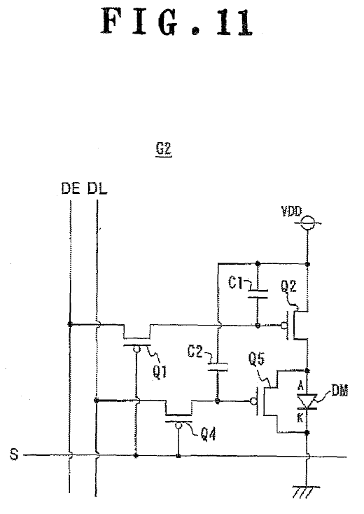

FIG. 11 shows the configuration of the pixel cell G2.

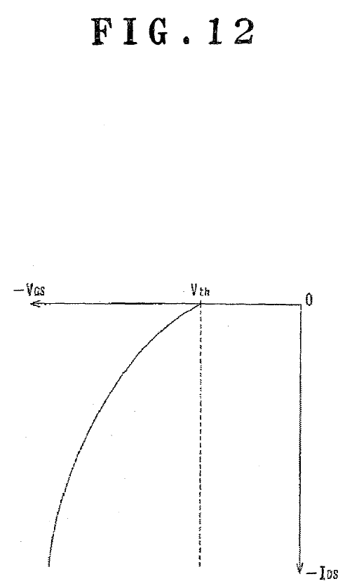

As shown in FIG. 11, the pixel cell G2 includes a dual display element DM having both an EL display function and a liquid crystal display function, a transistor Q1 for acquiring EL pixel data, a transistor Q2 for supplying a drive current, a transistor Q4 for acquiring liquid crystal pixel data, a transistor Q5 for driving liquid crystal, and capacitors C1 and C2. The transistors Q1, Q2, Q4 and Q5 are p-channel field-effect transistors, and FIG. 12 shows the characteristic of the gate-source voltage V_{GS} versus the drain-source current I_{DS} of the p-channel field-effect transistor.

In FIG. 11, the gate electrode of the transistor Q1 is connected to the scan line S, and the source electrode of the transistor Q1 is connected to the data line DE. The drain electrode of the transistor Q1 is connected to the gate electrode of the transistor Q2. The EL drive voltage VDD is applied to the source electrode of the transistor Q2 via the power supply electrode 11, and the capacitor C1 is connected between the gate and source electrodes of the transistor Q2. Furthermore, the drain electrode of the transistor Q2 is connected to the anode electrode A of the dual display element DM. The cathode electrode K of the dual display element DM is grounded via the ground electrode 12. The gate electrode of the transistor Q4 is connected to the scan line S, and the source electrode of the transistor Q4 is connected to the data line DL. The drain electrode of the transistor Q4 is connected to the gate electrode of the transistor Q5. The capacitor C2 is connected between the source electrode of the transistor Q2 and the gate electrodes of the transistor Q5. The source electrode of the transistor Q5 is connected to the anode electrode A of the dual display element DM, and the drain electrode of the transistor Q5 is connected to the cathode electrode K of the dual display element DM. The structure of the dual display element DM is the same as that shown in FIG. 2. The description thereof will therefore be omitted.

A drive control circuit 121 generates a scan timing signal according to an input image signal and supplies it to a scan driver 122. The drive control circuit 121 also supplies a display mode signal having a logical level of 1 to a data driver 113 when a display mode specifying signal indicates a liquid crystal display mode, while supplying the display mode signal having a logical level of 0 to the data driver 113 when the display mode specifying signal indicates an EL display mode. Furthermore, the drive control circuit 121 converts the input image signal into pixel data representing the brightness levels of the pixels and supplies them to the data driver 113.

The scan driver 122 sequentially applies scan pulses to the scan lines S₁ to Sₙ in the display panel 110 according to the scan timing signal. The data driver 113 generates various voltages and pixel data pulses (which will be described later) according to the display mode signal and the pixel data supplied from the drive control circuit 121 and applies them to the data lines DL₁ to DLₘ and DE₁ to DEₘ.

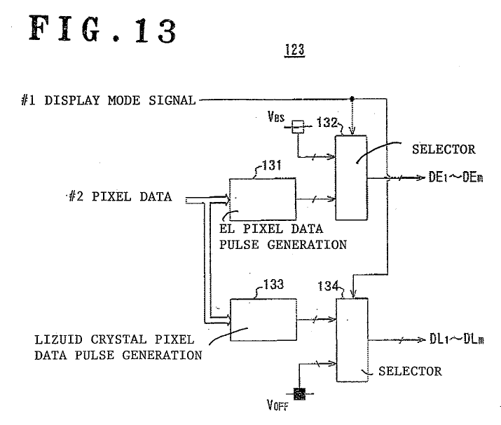

FIG. 13 shows the internal configuration of the data driver 123.

In FIG. 13, an EL pixel data pulse generation circuit 131 generates EL pixel data pulses for EL display according to the pixel data and supplies them to a selector 132 on a single scan line basis (m pulses). The selector 132 relays and supplies the EL pixel data pulses for one scan line (m pulses) supplied from the EL pixel data pulse generation circuit 131 to the data lines DE₁ to DEₘ in the display panel 110 when the display mode signal indicates a logical level of 0, that is, the EL display mode. On the other hand, the selector 132 applies a predetermined bias voltage V_{BS} to the data lines DE₁ to DEₘ when the display mode signal indicates a logical level of 1, that is, the liquid crystal display mode. It is noted that the bias voltage V_{BS} has a voltage value at which the transistor Q2 generates a predetermined fixed bias current when that voltage is applied to the gate electrode of the transistor Q2 via the data line DE and the transistor Q1. In particular, the bias voltage V_{BS} is set to a voltage value at which a bias current greater than a maximum current flowing through the dual display element DM during the liquid crystal display mode flows through the transistor Q2. The bias current does not necessarily have a fixed value, but may be changed as appropriate according to the state of the dual display element DM.

A liquid crystal pixel data pulse generation circuit 133 generates liquid crystal drive voltages VL_{DM} that drive the dual display elements DM as liquid crystal elements according to the pixel data and supplies liquid crystal pixel data pulses having pulse voltages, obtained by adding the threshold voltage Vₜₕ of the transistor Q5 to the liquid crystal drive voltages VL_{DM}, to a selector 134 on a single scan line basis (m pulses). The selector 134 relays and supplies the liquid crystal pixel data pulses for one scan line (m pulses) supplied from the liquid crystal pixel data pulse generation circuit 133 to the data lines DL₁ to DLₘ in the display panel 110 when the display mode signal indicates a logical level of 1, that is, the liquid crystal display mode. On the other hand, the selector 134 applies a predetermined switching off voltage V_{OFF} to the data lines DL₁ to DLₘ when the display mode signal indicates a logical level of 0, that is, the EL display mode. It is noted that the switching off voltage V_{OFF} has a voltage value at which the transistor Q5 is turned off when that voltage is applied to the gate electrode of the transistor Q5 via the data line DL and the transistor Q4.

The operation of the display device shown in FIG. 10 will now be described.

The display device is driven as an EL display device based on the following EL display mode when the display mode specifying signal indicates the EL display mode, while being driven as a liquid crystal display device based on the following liquid crystal display mode when the display mode specifying signal indicates the liquid crystal display mode.

### [EL Display Mode]

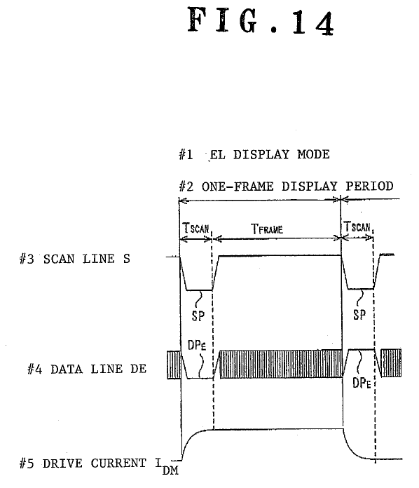

In the EL display mode, as shown in FIG. 14, the scan driver 122 sequentially applies a scan pulse SP having, for example, a pulse voltage of 0 volts, which is adequate enough to turn the transistor on, to the scan lines S₁ to Sₙ for each scan period T_{SCAN} in each frame display period. Furthermore, in the EL display mode, the data driver 123 applies the switching off voltage V_{OFF}, at which the transistor Q5 in the pixel cell G2 is turned off, to the data lines DL₁ to DLₘ. Moreover, the data driver 123 generates an EL pixel data pulse DP_{E} having a pulse voltage according to the pixel data shown in FIG. 14. The data driver 123 then applies these pulses to the data lines DE₁ to DEₘ on a single scan line basis (m pulses) synchronized with the application timing of each scan pulse SP.

According to such operation, whenever the scan pulse is applied via the scan line S, the transistor Q4 in each of the pixel cells G2 is turned on, so that the switching off voltage V_{OFF} is applied to the gate electrode of the transistor Q5 via the data line DL. The transistor Q5 is turned off in response to the application of the switching off voltage V_{OFF}. Furthermore, during the application of the scan pulse SP, the transistor Q1 in the pixel cell G2 is turned on, so that the EL pixel data pulse DP_{E} is applied to the gate electrode of the transistor Q2 and the capacitor C1 via the data line DE. Then, electric charge corresponding to the pulse voltage of the EL pixel data pulse DP_{E} is charged in the capacitor C1, so that the voltage across the capacitor C1 increases. The voltage generated in the capacitor C1 becomes the gate voltage of the transistor Q2. The transistor Q2 delivers a drive current I_{DM} according to the gate voltage to the dual display element DM during a display period T_{FRAME} shown in FIG. 14. During this period, the organic light emitting layer 104 in the dual display element DM emits light at the brightness level according to the drive current ID_{M}. That is, the dual display element DM operates as an EL display element.

### [Liquid Crystal Display Mode]

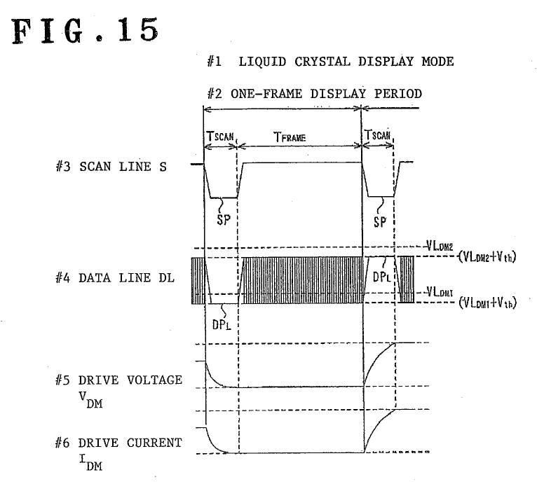

In the liquid crystal display mode, as in the EL display mode, the scan driver 122 generates the scan pulse SP for each scan period T_{SCAN} in each frame display period shown in FIG. 15 and sequentially applies it to the scan lines S₁ to Sₙ. Furthermore, in the liquid crystal display mode, the data driver 123 applies the bias voltage V_{BS}, at which the transistor Q2 in the pixel cell G2 should generate a predetermined fixed bias current, to the data lines DE₁ to DEₘ. Moreover, the data driver 123 generates the liquid crystal drive voltages VL_{DM} having voltage values according to the pixel data and applies liquid crystal pixel data pulses DP_{L} having pulse voltages, obtained by adding the threshold voltage Vₜₕ of the transistor Q5 to the liquid crystal drive voltages VL_{DM}, to the data lines DL₁ to DLₘ on a single scan line basis (m pulses) for each scan period T_{SCAN} as shown in FIG. 15. According to such operation, whenever the scan pulse is applied via the scan line S, the transistor Q1 in the pixel cell G2 is turned on, so that the bias voltage V_{BS} is applied to the gate electrode of the transistor Q2 via the data line DE. The transistor Q2 then delivers the bias current corresponding to the bias voltage V_{BS} to the dual display element DM. Furthermore, during the application of the scan pulse SP, the transistor Q4 in the pixel cell G2 is turned on, so that the liquid crystal pixel data pulse DP_{L} is applied to the gate electrode of the transistor Q5 via the data line DL. That is, the liquid crystal pixel data pulse DP_{L} having the pulse voltage obtained by adding the threshold voltage Vₜₕ of the transistor Q5 to the liquid crystal drive voltage VL_{DM} having the voltage value according to the pixel data (VL_{DM1} or VL_{DM2} in FIG. 15, for example) is applied to the gate electrode of the transistor Q5. The voltage applied to the gate electrode of the transistor Q5 is held by the capacitor C2. Therefore, during the display period T_{FRAME} shown in FIG. 15, a potential difference according to the voltage applied to the gate electrode of the transistor Q5 is generated between the anode electrode A and the cathode electrode K of the dual display element DM, and this potential difference is applied to the dual display element DM as the drive voltage V_{DM}. Then, the orientation of the liquid crystal molecules mixed in the carrier transport layer 103 in the dual display element DM changes according to the drive voltage V_{DM}. That is, the dual display element DM operates as a liquid crystal display element.

As described above, in the pixel cell G2 shown in FIG. 11, the transistor Q5, the source and drain electrodes of which are connected to the anode electrode A and the cathode electrode K of the dual display element DM, respectively, drives the dual display element DM as a liquid crystal element. That is, by applying the liquid crystal pixel data pulse DP_{L} having the pulse voltage obtained by adding the threshold voltage Vₜₕ of the transistor Q5 to the liquid crystal drive voltage VL_{DM} used to drive the dual display element DM as a liquid crystal element to the gate electrode of the transistor Q5, the dual display element DM is driven as a liquid crystal element. According to such driving, even when the voltage between the anode electrode A and the cathode electrode K of the dual display element DM is greater than the liquid crystal drive voltage VL_{DM}, the current flows through the transistor Q5 connected to the dual display element DM in parallel, so that the increase in voltage is cancelled. That is, the voltage between the anode electrode A and the cathode electrode K of the dual display element DM can be maintained at the liquid crystal drive voltage VL_{DM}. Furthermore, in the pixel cell G2 shown in FIG. 11, when the dual display element DM is driven as a liquid crystal element, the transistor Q2 for supplying the EL drive current is used to limit the drive current flowing through the dual display element DM to have a fixed bias current value. Therefore, even when the voltage-current characteristic of each of the transistors shows manufacturing-related variation, the dual display element DM can be driven as a liquid crystal element in a precise manner.

As described above, the display devices shown in FIGS. 1, 8 and 10 include drivers that generate EL pixel data pulses according to the brightness levels represented by the input image signal during the EL display mode, while generating liquid crystal pixel data pulses according to the brightness levels during the liquid crystal display mode. Furthermore, each pixel cell includes the dual display element having liquid crystal and EL display functions, and driving means for applying the EL drive voltages to the dual display element DM according to the EL pixel data pulses and applying the liquid crystal drive voltages according to the liquid crystal pixel data pulses. Such a configuration allows a single display panel to perform both liquid crystal display and EL display.

In the above embodiments, although p-channel field-effect transistors are employed as the transistors (Q1 to Q5) provided in the pixel cell G shown in FIG. 2, in the pixel cell G1 shown in FIG. 9 and the pixel cell G2 shown in FIG. 11, n-channel field-effect transistors may be employed.

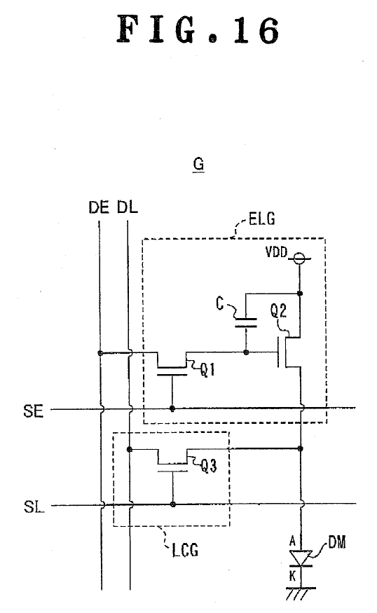

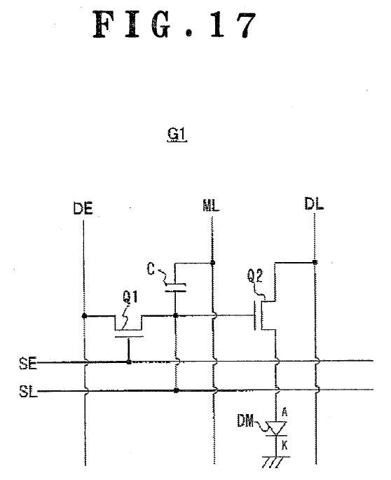

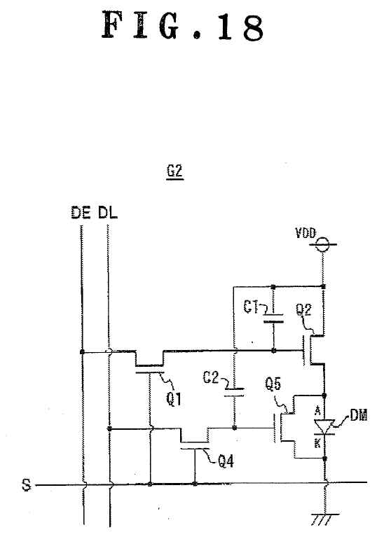

FIG. 16 shows another configuration of the pixel cell G when the transistors Q1 to Q3 shown in FIG. 2 are replaced with n-channel field-effect transistors. FIG. 17 shows another configuration of the pixel cell G1 when the transistors Q1 and Q2 shown in FIG. 9 are replaced with n-channel field-effect transistors. FIG. 18 shows another configuration of the pixel cell G2 when the transistors Q1, Q2, Q4 and Q5 shown in FIG. 11 are replaced with n-channel field-effect transistors.

The method for driving the dual display elements DM may be either an analog driving method in which voltages according to the brightness levels represented by the pixel data are applied to the dual display elements DM, or a digital driving method in which only binary voltages corresponding to maximum and minimum brightness are applied to the dual display elements DM.

1-7. (canceled)

8. A display device equipped with a display panel on which a plurality of pixel cells serving as pixels are formed, characterized in that the display device comprises:
a driver that generates an electroluminescence pixel data pulse according to the brightness level represented by pixel data for each pixel based on an input image signal during an EL display mode, while generating a liquid crystal pixel data pulse according to the brightness level represented by the pixel data during a liquid crystal display mode,
each of the pixel cells includes a display element capable of performing electroluminescence display operation and liquid crystal display operation, a first transistor that applies an electroluminescence drive voltage to the display element according to the EL pixel data pulse, and a second transistor that applies a liquid crystal drive voltage to the display element according to the liquid crystal pixel data pulse,
the second transistor is a p-channel field-effect transistor, the source electrode and the drain electrode of which are connected to the anode electrode and the cathode electrode of the display element, respectively, and
the liquid crystal drive voltage is generated between the anode electrode and the cathode electrode of the display element according to the liquid crystal pixel data pulse applied to the gate electrode of the second transistor.

9. The display device according to claim 8, characterized in that the liquid crystal pixel data pulse has a pulse voltage obtained by adding the threshold voltage of the second transistor to the liquid crystal drive voltage.

10. The display device according to claim 8, characterized in that the driver applies a predetermined bias voltage to the gate electrode of the first transistor to supply a predetermined bias current to the display element during the liquid crystal display operation.

11. The display device according to claim 8, characterized in that the second transistor is an n-channel field-effect transistor, the source electrode and the drain electrode of which are connected to the cathode electrode and the anode electrode of the display element, respectively, and
the liquid crystal drive voltage is generated between the anode electrode and the cathode electrode of the display element according to the liquid crystal pixel data pulse applied to the gate electrode of the second transistor.

12. The display device according to claim 9, characterized in that the driver applies a predetermined bias voltage to the gate electrode of the first transistor to supply a predetermined bias current to the display element during the liquid crystal display operation.
